(19) United States
(12) Patent Application Publication
(10) Pub. No.: US 2008/0176957 A1
(43) Pub. Date: Jul. 24, 2008

(54) PRESERVATIVE COMPOSITIONS COMPRISING RENEWABLY-BASED, BIODEGRADABLE 1,3-PROPANEDIOL

(75) Inventors: Melissa Joerger, Newark, DE (US); Gyorgyi Fenyvesi, Wilmington, DE (US)

Correspondence Address: MCCARTER & ENGLISH, LLP;BASIL S. KRIKELIS, Renaissance Centre, 405 N. King Street, 8th Floor, WILMINGTON, DE, 19801, US

(73) Assignee: DuPont Tate & Lyle Bio Products Company, LLC, Wilmington, DE (US)

(21) Appl. No.: 11/940,574

(22) Filed: Nov. 15, 2007

Related U.S. Application Data
(60) Provisional application No. 60/859,264, filed on Nov. 15, 2006.
(60) Provisional application No. 60/999,081, filed on Oct. 16, 2007.

(51) Int. Cl. A01N 31/02; A01P 1/00

(52) U.S. Cl. 514/738

(57) ABSTRACT

Disclosed herein are preservative compositions comprising 1,3-propanediol, wherein the 1,3-propanediol in said composition has a bio-based carbon content of about 1% to 100%. In addition, it is preferred that the 1,3-propanediol be biologically-derived, and wherein upon biodegradation, the biologically-derived 1,3-propanediol contributes no anthropogenic CO₂ emissions to the atmosphere.

### CROSS REFERENCE TO RELATED APPLICATIONS

The present application claims the benefit of U.S. Provisional Application Ser. No. 60/859,264 filed Nov. 15, 2006, and U.S. Provisional Application Ser. No. 60/999,081 filed Oct. 16, 2007, the disclosure of which is expressly incorporated herein by reference in its entirety.

### FIELD OF THE INVENTION

Disclosed herein are preservative compositions comprising 1,3-propanediol wherein the 1,3-propanediol in said composition has a bio-based carbon content of about 1% to about 100%. In addition, it is preferred that the 1,3-propanediol be biologically-derived, and wherein upon biodegradation, the biologically-derived 1,3-propanediol contributes no anthropogenic CO₂ emissions to the atmosphere.

### BACKGROUND OF THE INVENTION

Consumers consider many factors in selecting products for use. Recently certain factors have been a focus of and have driven scientific study and product development. These driving factors include, product safety, environmental impact, the extent to which the components are natural, and the aesthetic quality of the overall product. Therefore, manufacturers have to be concerned with the environmental impact of their products. In fact, the effort towards environmental impact awareness is a universal concern, recognized by government agencies. The Kyoto Protocol amendment to the United Nations Framework Convention on Climate Change (UNFCCC) currently signed by 156 nations is one example of a global effort to favor safer environmental manufacturing over cost and efficiency. The 2004 Co-operative Bank's annual Ethical Consumerism Report (www.co-operativebank.co.uk) disclosed a 30.3% increase in consumer spending on ethical retail products (a general classification for environmental safe, organic and fair trade goods) between 2003 and 2004 while total consumer spending during the same period rose only 3.7%.

Glycols such as ethylene glycol, propylene glycol, 1,3-butylene glycol, and 2-methyl-1,3-propanediol are biodegradable compounds useful in compositions ranging from preservative formulations to detergents to heat transfer compositions. While biodegradability is an important factor in protecting the environment, biodegradation of glycols derived from fossil-based sources has the unavoidable consequence of releasing previously fixed CO₂ into the atmosphere. Thus, while glycols in general are advantageous for their biodegradability, the resulting global warming potential of fossil-based glycols during biodegradation is significant.

Carbon dioxide is singled out as the largest component of the collection of greenhouse gases in the atmosphere. The level of atmospheric carbon dioxide has increased 50% in the last two hundred years. Recent reports indicate that the current level of atmospheric carbon dioxide is higher than the peak level in the late Pleistocene, the epoch before modern humans (Siegenthaler, U. et al. Stable Carbon Cycle-Climate Relationship During the Late Pleistocene, Science, Vol. 310, no. 5752 (Nov. 25, 2005), pp. 1313-1317). Therefore, any further addition of carbon dioxide to the atmosphere is thought to further shift the effect of greenhouse gases from stabilization of global temperatures to that of heating. Consumers and environmental protection groups alike have identified industrial release of carbon into the atmosphere as the source of carbon causing the greenhouse effect.

Greenhouse gas emission can occur at any point during the lifetime of a product. Consumers and environmental groups consider the full lifespan of a product when evaluating a product's environmental impact. Consumers look for products that do not contribute new carbon to the atmosphere considering the environmental impact of production, use and degradation. Only organic products composed of carbon molecules from plant sugars and starches and ultimately atmospheric carbon are considered to not further contribute to the greenhouse effect.

In addition to adding carbon dioxide to the atmosphere, current methods of industrial production of glycols produce contaminants and waste products that include among them sulfuric acid, hydrochloric acid, hydrofluoric acid, phosphoric acid, oxalic acid tartaric acid, acetic acids, Alkali metals, alkaline earth metals, transitional metals and heavy metals, including Iron, cobalt, nickel, copper, silver, molybdenum, tungsten, vanadium, chromium, rhodium, palladium, osmium, iridium, rubidium, and platinum (U.S. Pat. Nos. 2,434,110, 5,034,134, 5,334,778, and 5,10,036).

Glycols are commonly used as preservatives. Ethylene glycol (EG) has been used in many classrooms to preserve organisms in place of formaldehyde. EG, however, is toxic and is therefore not used food or personal care applications. Propylene glycol (PG), on the other hand, has been used as a preservative as well as a stabilizer in cosmetics, personal care products, pet food, bakery goods, food flavorings and salad dressings. PG, however, is a skin irritant and skin sensitizer. Kinnunen, et al. Acta Derm Venereol (Stockh) 1991; 71: 148-150. Safe alternatives to common glycols are constantly being considered, especially in personal care and cosmetic products.

Recently, 1,3-propanediol (PDO) has been disclosed for use in a cosmetic. See Japanese patent application no. JP 2005-15401, the entirety of which is incorporated herein by reference. According to Japanese patent application no. JP 2005-15401, the presence of PDO reduces the amount of preservative required in the cosmetic formulations. This reduction leads to a formulation that reduces skin irritation caused by the preservative. In essence, PDO is acting as a potentiator to reduce the amount of preservative required in the formulations and thus, reduce the corresponding amount of the preservative's negative effects.

Unfortunately, cosmetic formulations comprising PDO suffer from similar shortcomings as most chemically-based glycols. Chemically-based glycols generally contain impurities from the chemical processes used to generate them. Many such impurities are known to be harmful irritants, and in some cases, even toxic. For example, chemically synthesized PG is a known skin irritant/sensitizer. Kinnunen, et al. Formulations comprising chemically synthesized PDO may contain irritating, harmful and toxic impurities produced from the chemical processes used to generate it.

Cosmetics do not need to be sterile, but they must be adequately preserved or otherwise protected from microbial contamination and spoilage. See Cosmetic Microbiology: A Practical Approach, Chap 5. Contamination may occur during manufacturing or, more often, by the customer after repeated use of the cosmetic. Repeated opening of the cosmetic container and contact with skin and mucous membranes can result in contamination. Glycol preservatives may be used in cosmetics as either the preservative or a solvent carrier for another preservative. Glycols having antimicrobial/antifungal effects inhibit the growth of microorganisms while providing an effective preservative system to increase cosmetic and pharmaceutical product shelf life.

Consumers seek products that are composed of ingredients of a more purified source and/or of all natural composition. The inventors have discovered a new and useful glycol based composition that has superior properties.

### SUMMARY OF THE INVENTION

The present invention is directed to a preservative composition comprising biologically-derived 1,3-propanediol and an additive.

The present invention is also directed to compositions comprising a preservative wherein said preservative comprises biologically-derived 1,3-propanediol.

The present invention is also directed to a preservative composition comprising 1,3-propanediol having a bio-based carbon content of at least 1%

The present invention is also directed to a preservative composition comprising 1,3-propanediol having a bio-based carbon content of at least 1%, 5%, 10%, 25%, 50%, 75%, 90%, 99% or 100%

The present invention is also directed to a preservative composition comprising 1,3-propanediol wherein the 1,3-propanediol has an ultraviolet absorption at 220 nm of less than about 0.200 and at 250 nm of less than about 0.075 and at 275 nm of less than about 0.075; a “b” color value of less than about 0.15 and an absorbance at 275 nm of less than about 0.050; a peroxide concentration of less than about 10 ppm; a concentration of total organic impurities of less than about 400 ppm; and a concentration of carbonyl groups of less than about 10 ppm.

The present invention is also directed to a preservative composition comprising 1,3-propanediol, wherein the 1,3-propanediol in said composition has an anthropogenic CO₂ emission profile of about zero upon biodegradation.

The present invention is further directed to compositions comprising a preservative wherein said preservative comprises biologically-derived 1,3-propanediol.

### BRIEF DESCRIPTION OF THE DRAWINGS

FIG. 1 is a graph showing CO₂ emissions for CO₂ fixation from the atmosphere during photosynthesis for renewably based 1,3-propanediol (Bio-PDO™) (−1.7 kg CO₂/kg product) and CO₂ release to the atmosphere during biodegradation (kg CO₂/kg product) for ethylene glycol (EG) (+1.4 kg CO₂/kg product), propylene glycol (PG) (+1.7 kg CO₂/kg product), fossil-based 1,3-propanediol (Chem-PDO) (+1.7 kg CO₂/kg product), and fermentatively-derived 1,3-propanediol (Bio-PDO™) (+1.7 kg CO₂/kg product).

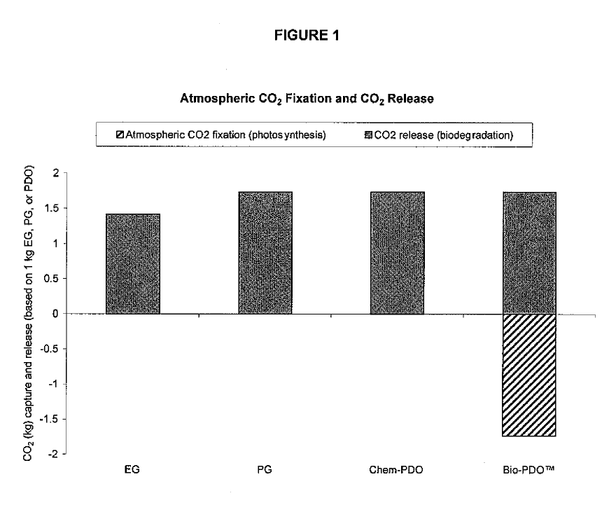

FIG. 2 is a graph showing that the net emissions of CO₂ to the atmosphere for renewably based 1,3-propanediol (Bio-PDO™) is zero (0).

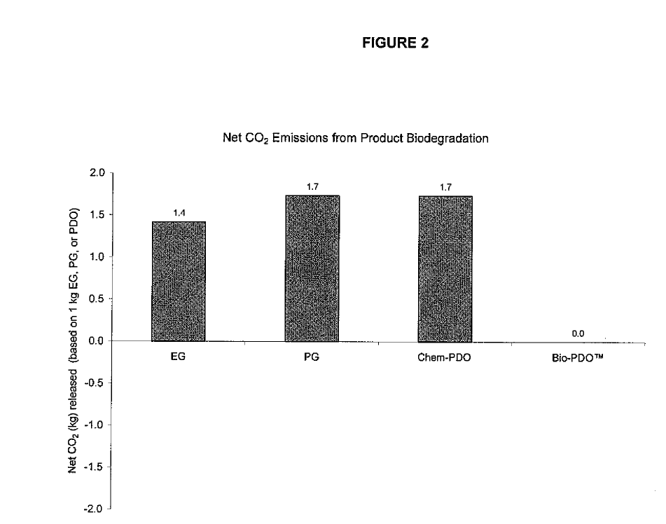

FIG. 3 is a table that shows the calculations for the data shown in FIGS. 1 and 2.

FIG. 4 shows modified repeated CTFA challenge test results.

### DETAILED DESCRIPTION OF THE INVENTION

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Compositions disclosed herein comprise 1,3-propanediol, having at least 1% bio-based carbon content, comprising up to 100% of the glycol component of the composition. In one embodiment, the 1,3-propanediol comprises substantially all of the glycol component of the composition of the invention. In another embodiment, the 1,3-propanediol comprises all of the glycol component of the composition.

The primary object of the present invention is to provide a preservative composition with superior properties. The preservative composition of the present invention provides improved compatibility when the preservative composition is contacted with skin. The preservative composition of the present invention contain less harmful irritants and toxic materials.

The present invention also provides compositions, such as cosmetic and personal care compositions, that comprise the preservative composition of the invention.

1,3-Propanediol

The terms “bioPDO”, “biologically-derived, biodegradable 1,3-propanediol”, “biologically-derived 1,3-propanediol”, “renewably-based 1,3-propanediol”, “renewably-based, biodegradable 1,3-propanediol,” “biosourced, and “biologically-produced 1,3-propanediol” and similar terms as used herein to refer to 1,3-propanediol derived from microorganism metabolism of plant-derived sugars composed of carbon of atmospheric origin, and not composed of fossil-fuel carbon.

Anthropogenic CO₂ Emission Profile

The preservative compositions of the invention comprise renewably-based, biodegradable 1,3-propanediol, in which said renewably-based, biodegradable 1,3-propanediol has an anthropogenic CO₂ emission profile of about zero (0). An “anthropogenic emission profile” means anthropogenic CO₂ emissions that are contributed to the atmosphere upon biodegradation of a compound or composition.

“Biodegradable” or “Biodegradability” means the capacity of a compound to be broken down by living organisms to simple, stable compounds such as carbon dioxide and water.

Whereas photosynthesis is the process of creating growing matter through the conversion of carbon dioxide (CO₂) and water (H₂O) into plant material through the action of the sun, biodegradation is the process of converting organic material back into CO₂ and H₂O through the activity of living organisms.

There are many published test methods for measuring the biodegradability of organic chemicals such as glycols. One internationally recognized method is ASTM E1720-01, Standard Test Method for Determining Ready, Ultimate Biodegradability of Organic Chemicals in a Sealed Vessel CO₂ Production Test.

Chemicals that demonstrate 60% biodegradation or better in this test method will biodegrade in most aerobic environments and are classified as “ready biodegradable.” All of the glycols referred to in this document meet this criteria.

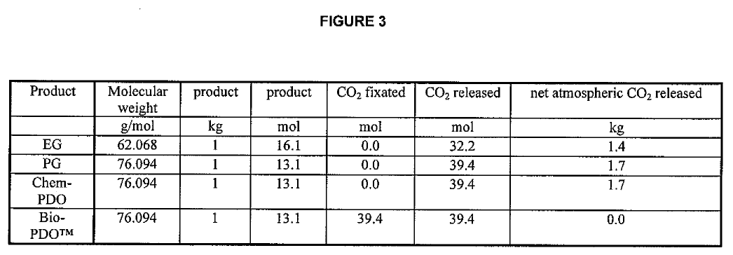

Calculations setting forth the finding that the 1,3-propanediol of the present invention provides no anthropogenic CO₂ emissions upon biodegradation is set forth below. A table in support of these calculations is provided in FIG. 3.

When one molecule of 1,3-propanediol degrades, three molecules of CO₂ are released into the atmosphere. Because all of these molecules of CO₂ released during degradation from “fermentatively-derived” 1,3-propanediol have an atmospheric origin, the net release of CO₂ to the atmosphere is thus zero. Comparatively, because a fossil fuel-derived propylene glycol and fossil-derived 1,3-propanediol contains three carbon atoms which originate from a fixed carbon source (i.e., the fossil fuel), degradation of one molecule of fossil fuel-derived propylene glycol or 1,3-propanediol results in a net release of three molecules of CO₂ into the atmosphere. Similarly, because fossil fuel-derived ethylene glycol contains two carbon atoms, which originate from a fixed carbon source, degradation of one molecule of fossil fuel-derived ethylene glycol results in a net release of two molecules of CO₂ into the atmosphere.

In order to quantify the CO₂ released for one kilogram of each ethylene glycol, propylene glycol, chemical 1,3-propanediol and “fermentatively-derived” 1,3 propanediol (Bio-PDO™), the product weight (1 kg) is divided by its molecular weight. For each carbon atom present in the molecule, one molecule of CO₂ is released. The molecules of CO₂ are multiplied by the molecular weight of CO₂ (44 kg/kmole) to quantify the impact of CO₂ release (kg) per one unit (kg) of product.

Fossil-Fuel Based Carbon Feedstock Release

1 kg of fossil fuel derived ethylene glycol*(1 kmol EG/62.068 kg)*(2 kmol CO₂/1 kmol EG)*(44 kg CO₂/kmol CO₂)=1.4 kg CO₂

1 kg of fossil fuel derived propylene glycol*(1 kmol PG/76.094 kg)*(3 kmol CO₂/1 kmol PG)*(44 kg CO₂/kmol CO₂)=1.7 kg CO₂

1 kg of fossil fuel derived 1,3-propanediol*(1 kmol chem-PDO/76.094 kg)*(3 kmol CO₂/1 kmol chem-PDO)*(44 kg CO₂/kmol CO₂)=1.7 kg CO₂

Bio-Based Carbon Feedstock Balance

Capture:

1 kg of Bio-PDO™*(1 kmol Bio-PDO™/76.094 kg)*(−3 kmol CO₂/1 kmol Bio-PDO™)*(44 kg CO₂/kmol CO₂)=−1.7 kg CO₂

Release:

1 kg of Bio-PDO™*(1 kmol Bio-PDO™/76.094 kg)*(3 kmol CO₂/1 kmol Bio-PDO™)*(44 kg CO₂/kmol CO₂)=1.7 kg CO₂

Net:

−1.7 kg+1.7 kg=0 kg

This Bio-based Carbon Feedstock Balance result demonstrates that there are no anthropogenic CO₂ emissions from the biodegradation of the renewably sourced Bio-PDO™. The term “anthropogenic” means man-made or fossil-derived.

Bio-Based Carbon

“Carbon of atmospheric origin” as used herein refers to carbon atoms from carbon dioxide molecules that have recently, in the last few decades, been free in the earth's atmosphere. Such carbons in mass are identifiable by the presence of particular radioisotopes as described herein. “Green carbon”, “atmospheric carbon”, “environmentally friendly carbon”, “life-cycle carbon”, “non-fossil fuel based carbon”, “non-petroleum based carbon”, “carbon of atmospheric origin”, and “biobased carbon” are used synonymously herein.

“Carbon of fossil origin” as used herein refers to carbon of petrochemical origin. Such carbon has not been exposed to UV rays as atmospheric carbon has, therefore masses of carbon of fossil origin has few radioisotopes in their population. Carbon of fossil origin is identifiable by means described herein. “Fossil fuel carbon”, “fossil carbon”, “polluting carbon”, “petrochemical carbon”, “petro-carbon” and carbon of fossil origin are used synonymously herein.

The abbreviation “IRMS” refers to measurements of CO₂ by high precision stable isotope ratio mass spectrometry.

The term “carbon substrate” means any carbon source capable of being metabolized by a microorganism wherein the substrate contains at least one carbon atom.

“Renewably-based” denotes that the carbon content of the 1,3-propanediol is from a “new carbon” source as measured by ASTM test method D 6866-05 Determining the Biobased Content of Natural Range Materials Using Radiocarbon and Isotope Ratio Mass Spectrometry Analysis, incorporated herein by reference. This test method measures the C-14/C-12 isotope ratio in a sample and compares it to the C-14/C-12 isotope ratio in a standard 100% biobased material to give percent biobased content of the sample. “Biobased materials” are organic materials in which the carbon comes from recently (on a human time scale) fixated CO₂ present in the atmosphere using sunlight energy (photosynthesis). On land, this CO₂ is captured or fixated by plant life (e.g., agricultural crops or forestry materials). In the oceans, the CO₂ is captured or fixated by photosynthesizing bacteria or phytoplankton. A biobased material has a C-14/C-12 isotope ratio in range of from 1:0 to greater than 0:1. Contrarily, a fossil-based material, has a C-14/C-12 isotope ratio of 0:1.

A small amount of the carbon dioxide in the atmosphere is radioactive. This 14C carbon dioxide is created when nitrogen is struck by an ultra-violet light produced neutron, causing the nitrogen to lose a proton and form carbon of molecular weight 14 which is immediately oxidized in carbon dioxide. This radioactive isotope represents a small but measurable fraction of atmospheric carbon. Atmospheric carbon dioxide is cycled by green plants to make organic molecules during the process known as photosynthesis. The cycle is completed when the green plants or other forms of life metabolize the organic molecules producing carbon dioxide which is released back to the atmosphere. Virtually all forms of life on Earth depend on this green plant production of organic molecule to produce the chemical energy that facilitates growth and reproduction. Therefore, the 14C that exists in the atmosphere becomes part of all life forms, and their biological products. These renewably based organic molecules that biodegrade to CO₂ do not contribute to global warming as there is no net increase of carbon emitted to the atmosphere. In contrast, fossil fuel based carbon does not have the signature radiocarbon ratio of atmospheric carbon dioxide.

Atmospheric origin and fixed carbon source as used herein are relative terms in that the time period of when CO₂ is of atmospheric or fixed origin relates to the life cycle of the 1,3-propanediol. Thus, while it is quite possible that, at one time, carbon from a fossil fuel was found in the atmosphere (and, as a corollary, that atmospheric CO₂ may one day be incorporated into a fixed carbon source), for purposes herein carbon is considered to be from a fixed carbon source until it is released into the atmosphere by degradation.

Assessment of the renewably based carbon in a material can be performed through standard test methods. Using radiocarbon and isotope ratio mass spectrometry analysis, the biobased content of materials can be determined. ASTM International, formally known as the American Society for Testing and Materials, has established a standard method for assessing the biobased content of materials. The ASTM method is designated ASTM-D6866.

The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modem reference standard. The ratio is reported as a percentage with the units “pMC” (percent modern carbon). If the material being analyzed is a mixture of present day radiocarbon and fossil carbon (containing no radiocarbon), then the pMC value obtained correlates directly to the amount of Biomass material present in the sample.

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent biobased content result of 93%.

A sample of“fermentatively-derived” 1,3-propanediol was submitted by DuPont to Iowa State University for biobased content analysis using ASTM method D 6866-05. The results received from Iowa State University demonstrated that the above sample was 100% bio-based content (ref: Norton,Glenn. Results of Radiocarbon Analyses on samples from DuPont Bio-Based Materials—reported Jul. 8, 2005).

Assessment of the materials described herein were done in accordance with ASTM-D6866. The mean values quoted in this report encompass an absolute range of 6% (plus and minus 3% on either side of the biobased content value) to account for variations in end-component radiocarbon signatures. It is presumed that all materials are present day or fossil in origin and that the desired result is the amount of biobased component “present” in the material, not the amount of biobased material “used” in the manufacturing process.

Results of Radiocarbon Analyses on Samples from DuPont Bio-Based

Materials

Reported Jul. 8, 2005

| PRODUCT | BIOBASED CONTENT (%) |
|---|---|
| 1,3-Propanediol | 100 |

There may be certain instances wherein a preservative composition of the invention may comprise a combination of a biologically-derived 1,3-propanediol and one or more non biologically-derived glycol components, such as, for example, chemically synthesized 1,3-propanediol. In such occasions, it may be difficult, if not impossible to determine which percentage of the glycol composition is biologically-derived, other than by calculating the bio-based carbon content of the glycol component. In this regard, in the preservative compositions of the invention, the glycol component, and in particular, the 1,3-propanediol, can comprise at least about 1% bio-based carbon content up to 100% bio-based carbon content, and any percentage therebetween.

Purity

“Substantially purified,” as used by applicants to describe the biologically-produced 1,3-propanediol produced by the process of the invention, denotes a composition comprising 1,3-propanediol having at least one of the following characteristics: 1) an ultraviolet absorption at 220 nm of less than about 0.200 and at 250 nm of less than about 0.075 and at 275 nm of less than about 0.075; or 2) a composition having L*a*b* “b*” color value of less than about 0.15 and an absorbance at 270 nm of less than about 0.075; or 3) a peroxide composition of less than about 10 ppm; or 4) a concentration of total organic impurities of less than about 400 ppm.

A “b*” value is the spectrophotometrically determined Yellow Blue measurement as defined by the CIE L*a*b* measurement ASTM D6290.

The abbreviation “AMS” refers to accelerator mass spectrometry.

By the acronym “NMR” is meant nuclear magnetic resonance.

By the terms “color” and “color bodies” is meant the existence of visible color that can be quantified using a spectrocolorimeter in the range of visible light, using wavelengths of approximately 400-800 nm, and by comparison with pure water. Reaction conditions can have an important effect on the nature of color production. Examples of relevant conditions include the temperatures used, the catalyst and amount of catalyst. While not wishing to be bound by theory, we believe color precursors include trace amounts of impurities comprising olefinic bonds, acetals and other carbonyl compounds, peroxides, etc. At least some of these impurities may be detected by such methods as UV spectroscopy or peroxide titration.

“Color index” refers to an analytic measure of the electromagnetic radiation-absorbing properties of a substance or compound.

Biologically-derived 1,3-propanediol useful in preservative compositions disclosed herein has at least one of the following characteristics: 1) an ultraviolet absorption at 220 nm of less than about 0.200 and at 250 nm of less than about 0.075 and at 275 nm of less than about 0.075; or 2) a composition having L*a*b* “b*” color value of less than about 0.15 and an absorbance at 270 nm of less than about 0.075; or 3) a peroxide composition of less than about 10 ppm; or 4) a concentration of total organic impurities of less than about 400 ppm.

The level of 1,3-propanediol purity can be characterized in a number of different ways. For example, measuring the remaining levels of contaminating organic impurities is one useful measure. Biologically-derived 1,3-propanediol can have a purity level of less than about 400 ppm total organic contaminants; preferably less than about 300 ppm; and most preferably less than about 150 ppm. The term ppm total organic purity refers to parts per million levels of carbon-containing compounds (other than 1,3-propanediol) as measured by gas chromatography.

The type of 1,3-propandiol impurities can be characterized in a number of different ways. For example, the molecular weight of the each impurity's parent compound and it fragmentation pattern can be determined by chromatographic mass spectrometry techniques (i.e. LC/MS or GC/MS). Biologically-derived 1,3-propanediol has a chemically distinct impurity profile as compare to chemical-based 1,3-propanediol. Biologically-derived 1,3-propanediol can have an impurity profile that is non-toxic and that is not a skin irritant. For example, biologically-derived 1,3-propanediol is found to have an impurity profile that does not contain the toxic, harmful compound known as acrolein, a suspected human carcinogen. Feng, Z; Hu W, Hu Y, Tang M (October 2006). Proceedings of the National Academy of Sciences of the United States of America 103 (42): 15404-15409.

Biologically-derived 1,3-propanediol can also be characterized using a number of other parameters, such as ultraviolet light absorbance at varying wavelengths. The wavelengths 220 nm, 240 nm and 270 nm have been found to be useful in determining purity levels of compositions comprising biologically-derived 1,3-propanediol. Biologically-derived 1,3-propanediol can have a purity level wherein the UV absorption at 220 nm is less than about 0.200 and at 240 nm is less than about 0.075 and at 270 nm is less than about 0.075.

Biologically-derived 1,3-propanediol can have a b* color value (CIE L*a*b*) of less than about 0.15.

The purity of biologically-derived 1,3-propanediol compositions can also be assessed in a meaningful way by measuring levels of peroxide. Biologically-derived 1,3-propanediol can have a concentration of peroxide of less than about 10 ppm.

It is believed that the aforementioned purity parameters for biologically-derived and purified 1,3-propanediol (using methods similar or comparable to those disclosed in U.S. Patent Application No. 2005/0069997) distinguishes such compositions from 1,3-propanediol compositions prepared from chemically purified 1,3-propanediol derived from petroleum sources, as per the prior art.

Fermentation

“Biologically produced” means organic compounds produced by one or more species or strains of living organisms, including particularly strains of bacteria, yeast, fungus and other microbes. “Bio-produced” and biologically produced are used synonymously herein. Such organic compounds are composed of carbon from atmospheric carbon dioxide converted to sugars and starches by green plants.

“Biologically-based” means that the organic compound is synthesized from biologically produced organic components. It is further contemplated that the synthesis process disclosed herein is capable of effectively synthesizing other monoesters and diesters from bio-produced alcohols other than 1,3-propanediol; particularly including ethylene glycol, diethylene glycol, triethylene glycol, 1,2-propylene glycol, dipropylene diol, tripropylene diol, 2-methyl 1,3-propanediol, neopentyl glycol and bisphenol A.

“Fermentation” as used refers to the process of metabolizing simple sugars into other organic compounds. As used herein fermentation specifically refers to the metabolism of plant derived sugars, such sugar are composed of carbon of atmospheric origin.

Biologically-derived 1,3-propanediol can be obtained based upon use of the fermentation broth (“fermentatively-derived”) generated by a genetically-engineered Eschericia coli (E. coli) previously disclosed in, for example, U.S. Pat. No. 5,686,276. However, other single organisms, or combinations of organisms, may be used to biologically produce 1,3-propanediol, using organisms that have been genetically-engineered according to methods known in the art. “Fermentation” also refers to a system that catalyzes a reaction between substrate(s) and other nutrients to product(s) through use of a biocatalyst. The biocatalysts can be a whole organism, an isolated enzyme, or any combination or component thereof that is enzymatically active. Fermentation systems useful for producing and purifying biologically-derived 1,3-propanediol are disclosed in, for example, Published U.S. Patent Application No. 2005/0069997, the entirety of which is incorporated herein by reference.

The biologically-derived 1,3-propanediol (Bio-PDO™) for use in the current invention, produced by the process described herein, contains carbon from the atmosphere incorporated by plants, which compose the feedstock for the production of Bio-PDO™. In this way, the Bio-PDO™ used in the compositions of the invention contains only renewable carbon, and not fossil fuel based, or petroleum based carbon. Therefore the compositions of the invention have less impact on the environment as the propanediol used in the compositions does not deplete diminishing fossil fuels and, upon degradation releases carbon back to the atmosphere for use by plants once again. Thus, the present invention can be characterized as more natural and having less environmental impact than similar compositions comprising petroleum based glycols.

Moreover, as the purity of the Bio-PDO™ utilized in the compositions of the invention is higher than chemically synthesized 1,3-propanediol and other glycols, risk of introducing impurities that may cause irritation is reduced by its use over commonly used glycols, such as propylene glycol. This 1,3-propanediol of the invention can be isolated from the fermentation broth and incorporated into preservative compositions of the invention by processes as are known to those of ordinary skill in the applicable art.

Renewably-Based, Biodegradable 1,3-Propanediol Containing Preservative Compositions

“Preservative compositions” as used herein refers to compositions that suppress the growth of microorganisms or germs, and includes compositions having antimicrobial, antiseptic, antiviral or antifungal capacity.

As mentioned above, 1,3-propanediol can be incorporated into numerous compositions as a glycol component. For example, 1,3-propanediol can be part of or the sole glycol component of preservative compositions.

It is contemplated herein that other renewably-based or biologically-derived glycols, such as ethylene glycol, dietheylene glycol, triethylene glycol, 1,2-propylene glycol, dipropylene glycol, tripropylene glycol, neopentyl glycol and bisphenol A, among others, can be used in the preservative in compositions of the present invention.

In the preservative compositions, Bio-PDO™ can serve as a preservative, an antifungal, an antiviral or an antimicrobial. Bio-PDO™ may be used in cosmetics as either the preservative or a solvent carrier for another preservative. For instance, Bio-PDO™ is useful as a solvent in botanical extracts to provide antimicrobial protection. Botanical extracts are made by soaking a part of the plant in liquid. The liquid retains natural compounds from within the plant. Bacteria, viruses, fungi, and protozo may also be collected in the retained liquid. The presence of Bio-PDO™ inhibits the growth of these microorganisms.

Bio-PDO™ can also be used as a solvent in the preservative systems. For instance, Bio-PDO™ is useful as solvent in common paraben and non-paraben preservative systems. Paraben and non-paraben preservatives may be blended with Bio-PDO™ in oil-in-water (cream) formulations to provide antimicrobial protection equivalent to other known glycol preservatives.

Typical Broad Formulations for Certain End Use Applications

Bio-PDO™ can be used alone as the preservative or as part of a solvent composition. Bio-PDO™ can be present in preservative compositions in amounts well known to those of ordinary skill in the appropriate art, typically the concentration ranges are from about 0.001% to about 100%. Preferably, Bio-PDO™ can be present in preservative compositions in concentration ranges from about 0.1% to about 75%. More preferably, the range can be from about 1% to about 20%.

Bio-PDO™ can be present in as a solvent in preservative compositions in concentration ranges from about 1% to about 100%. Preferably, the range can be from about 50% to about 100%. Most preferably, the range is from about 70% to about 99.9%. Bio-PDO™ can be used as a mixture with other compounds, such as alcohols (methanol, ethanol, propanol, isopropanol, butanol), glycols (1,2-propanediol, ethylene glycol, 1,3-butanediol), water or with Bio-PDO™-esters. A preferred application is the use of preservative solvents comprising Bio-PDO™ to perform botanical extractions and preserve the extracted solution with less microbial or fungal growth that would be present without the preservative. Table 1 lists the solubility of common preservatives in Bio-PDO™ and PG.

TABLE 1

| | | Solubility in Bio- | Solubility in | |
|---|---|---|---|---|
| Compound | Wt % | PDO ™ | PG | Notes |
| Ethanol | 50 | Soluble | Soluble | |
| IPA | 50 | Soluble | Soluble | |
| 1,4-Butanediol | 50 | Soluble | Soluble | |
| Glycerol | 50 | Soluble | Soluble | Mixing |
| | | | | required to |
| | | | | make |
| | | | | uniform soln |

Bio-PDO™ can also be used as a solvent to make blends, emulsions, suspensions or dispersions of a preservative or preservatives. Cosmetic preservative blends need a broad range of protection against gram positive and negative bacteria, yeasts and molds. In cosmetics, solubility is also important. Clear solutions are preferred to emulsions, suspensions or dispersions. The use of Bio-PDO™ may be used to provide an easy to handle liquid (or dispersion, or suspension) which disperses readily in cold systems as well. Table 2 shows the solubility of the most common preservatives used in cosmetic applications. Other preservatives or a mixture of preservatives can be used with Bio-PDO™, such as choloracetamide sodium benzoate, 5-bromo-5-nitro-1,3-dioxane, butyl paraben, ethyl paraben, isobutyl paraben, iodopropynyl butylcarbamate, and 2,4,4′-trichloro-2′-hydroxy ether.

TABLE 2

| | | Solubility | | |
|---|---|---|---|---|
| | | in Bio- | Solubility in | |
| Preservative | Wt % | PDO ™ | PG | Notes |
| Irgasan | 20 | Soluble | Soluble | |
| Salicyclic acid | 10 | Soluble | Soluble | |
| Salicyclic acid | 15 | Soluble | Soluble | |
| Salicyclic acid | 20 | Not Soluble | Soluble | |
| Methyl paraben | 10 | Soluble | Soluble | Solubility appears |
| | | | | higher in PG |
| Methyl paraben | 15 | Not Soluble | Soluble | |
| Methyl paraben | 20 | Not Soluble | Not Soluble | Solubility appears |
| | | | | higher in PG |

Bio-PDO™ can be mixed with other compounds or additives, such as alcohols or Bio-PDO™ esters, in preservative compositions or to enhance the solubility of preservatives. The preferred concentration range of Bio-PDO™ or the preservative active is about 0.001% to about 100%.

Examples of end use applications that can incorporate the preservative of the invention include cosmetic and personal care applications such as creams, lotions, deodorants, soaps, mascara, foundation, eye-liner, eye-shadow, cleanser, body wash, hand sanitizers, skin care, facial care, facial cleansing, body care, baby care, shower & bath toiletries, oral care, hand washing, antiperspirants, depilatory products, mouth wash and rinse, shaving cream, shaving lotion, shaving foam, foot care, shampoos, perfumes, conditioners & hair styling product, hair detangling products, sun protection, and after-sun & self-tanning products.

In cosmetic and personal care applications, the preferred concentration range of Bio-PDO™ in said preservative is from about 0.001% to about 99.9%, a more preferred concentration range is from about 0.01% to about 75%, a more preferred concentration range is from about 0.01% to about 20%, a more preferred concentration range is about 0.01% to about 3.0%, and a most preferred concentration range is from about 0.1% to about 2.0%.

Other examples of end use applications that can incorporate the preservative of the invention include food applications such as fruit preservation, beverages—flavor and fragrances, multilayer edible moisture barrier for food products, packaging for fresh fish food, fish food preservation, preservation of intermediate moisture foods (controlling humidity and inhibition of mold), enzyme-containing formulations for decomposing food waste, cereals, enzyme-preservation (for enzymes used in food preparations and processing), whip-able food products, edible film strips, creams, chewing gums, food coloring paste, pastry dough, bakery products (bread, pie, cake, cookies), chocolate and edible inks (for edible substrates), and appetite suppressant mouth spray.

In food applications, the preferred concentration range of Bio-PDO™ in said preservative is from about 0.001% to about 99.9%, a more preferred concentration range is from about 0.1% to about 50%, a more preferred concentration range is from about 0.1% to about 20%, and a most preferred concentration range is from about 0.1% to about 15%.

Additional examples of end use applications that can incorporate the preservative of the invention include tobacco applications such as flavor and fragrances and preservative in tobacco products. In tobacco applications, the preferred concentration range of Bio-PDO™ in said preservative is from about 0.001% to about 99.9%, a more preferred concentration range is from about 0.1% to about 20%, a more preferred concentration range is from about 0.1% to about 10%, and a most preferred concentration range is from about 0.1% to about 5%.

The preservative of the invention can also be incorporated into pharmaceutical applications such as medication creams and lotions, ointments and antiperspirants. In pharmaceutical applications, the preferred concentration range of Bio-PDO™ in said preservative is from about 0.001% to about 99.9%, a more preferred concentration range is from about 0.1% to about 50%, a more preferred concentration range is from about 0.1% to about 20%, and a most preferred concentration range is from about 0.1% to about 10%.

The preservative of the invention can also be incorporated into detergent applications such as laundry and dishwashing detergents—flavor and fragrances, car wash soap or shampoo, and disinfectants and sanitizer fluids for use in places including hospitals, emergency rooms, schools and food stores. In detergent applications, the preferred concentration range of Bio-PDO™ preservative is from about 0.001% to about 99.9%, a more preferred concentration range is from about 0.1% to about 50%, and a most preferred concentration range is from about 0.1% to about 30%.

In other embodiments, the preservative of the invention can be incorporated into home care applications such as cleaning products—flavor and fragrances, hard surface cleaners, window cleaners, carpet cleaners, air fresheners and reed diffusers. In home care applications, the preferred concentration range of Bio-PDO™ in said preservative is from about 0.001% to about 99.9%, a more preferred concentration range is from about 0.01% to about 50%, and a most preferred concentration range is from about 0.1% to about 25%.

In even other embodiments, the preservative of the invention can be incorporated into lubricant applications such as lubricants, sanitizers and disinfectants for equipment and parts including conveyor chains, extruder parts in food processing, food packaging container and food contact surfaces. In lubricant applications, the preferred concentration range of Bio-PDO™ in said preservative is from about 0.001% to about 99.9%, a more preferred concentration range is from about 0.1% to about 30%, a more preferred concentration range is from about 0.1% to about 20%, and a most preferred concentration range is from about 0.1% to about 10%.

Alternatively, the preservative of the invention can be incorporated into paint and coating applications such as inks and paints. In painting and coating applications, the preferred concentration range of Bio-PDO™ in said preservative is from about 0.001% to about 99.9%, a more preferred concentration range is from about 0.1% to about 50%, and a most preferred concentration range is from about 0.1% to about 25%.

Additionally, examples of end use applications that can incorporate the preservative of the invention include animal food applications such as semi-moist cat and dog food; cryopreservation applications such as human and animal cell, tissue and organ preservation; agriculture applications such as frost protection (orchards, coffee beans plantations and golf courses), antibacterial/antifungal treatment of crops and seeds. In animal food applications, the preferred concentration range of Bio-PDO™ in said preservative is from about 0.001% to about 99.9%, a more preferred concentration range is from about 0.1% to about 20%, a more preferred concentration range is from about 0.1% to about 10%, and a most preferred concentration range is from about 0.1% to about 5%. In cryopreservation applications, the preferred concentration range of preservative is from about 0.001% to about 99.9%, a more preferred concentration range is from about 0.1% to about 75%, and a most preferred concentration range is from about 0.1% to about 50%. In agriculture applications, the preferred concentration range of preservative is from about 0.001% to about 99.9%, a more preferred concentration range is from about 0.1% to about 50%, and a most preferred concentration range is from about 0.1% to about 30%.

The preferred concentration range of preservative in an end use application is from about 0.001% to about 5%, more preferably from about 0.01% to about 3%, and most preferably from about 0.1% to about 2%. However, these ranges may vary depending upon the particular end use, and those of ordinary skill in the art would recognize the appropriate amount of preservative to be used in such end uses.

Set forth in this section are general, broad range formulations for a handful of preservative end use applications intended to provide the reader with a general idea of the variety of applications and uses for preservative. This section is by no means intended to be limiting in any way, and those having skill in the art can readily determine appropriate uses of preservative as a glycol component in all other known preservative products as well as uses for preservatives comprising Bio-PDO™.

### Ingredient Listings:

Preservative compositions of the invention preferably contain Bio-PDO™ and one or more conventional additives including, but not limited to, carriers; actives; fillers; surfactants; thixotropic agents; antioxidants; preserving agents; dyes; pigments; fragrances; thickeners; vitamins; hormones; moisturizers; UV absorbing sunscreens; UV scattering inorganic sunscreens; wetting agents; cationic, anionic, nonionic, or amphoteric polymers; and hair coloring active substances. The additive may be chosen for suitability with the desired application or composition as is known to one of skill in the art. For example, pharmaceutical formulations is a well-established art, and is further described in Gennaro (ed.), Remington: The Science and Practice of Pharmacy, 20.sup.th ed., Lippincott, Williams & Wilkins (2000) (ISBN: 0683306472); Ansel et al., Pharmaceutical Dosage Forms and Drug Delivery Systems, 7.sup.th ed., Lippincott Williams & Wilkins Publishers (1999) (ISBN: 0683305727); and Kibbe (ed.), Handbook of Pharmaceutical Excipients American Pharmaceutical Association, 3.sup.rd ed. (2000) (ISBN: 091733096X), the disclosures of which are incorporated herein by reference in their entireties, and thus need not be described in detail herein.

Conventional organic anti-microbial agents may be used in the compositions of the present invention. Levels of anti-microbial agent incorporation may also range from about 0.001% to about 75%, preferably from about 0.01% to about 3% or more preferably from about 0.03% to about 0.5% by weight of the composition in which they are present. Most of the classes of agents commonly used in the art can be utilised. Preferred additional organic anti-microbials are bactericides, for example quaternary ammonium compounds, like cetyltrimethylammonium salts; chlorhexidine and salts thereof; and diglycerol monocaprate, diglycerol monolaurate, glycerol monolaurate, and similar materials, as described in “Deodorant Ingredients”, S. A. Makin and M. R. Lowry, in “Antiperspirants and Deodorants”, Ed. K. Laden (1999, Marcel Dekker, New York). More preferred additional anti-microbials for use in the compositions of the invention are polyhexamethylene biguanide salts; 2,4,4′-trichloro,2′-hydroxy-diphen-yl ether (triclosan); and 3,7,11-trimethyidodeca-2,6,10-trienol (farnesol).

Inorganic anti-microbial agents may also be used in the compositions of the invention. Examples are often selected from astringent active salts, including, in particular, aluminium, zirconium and mixed aluminium/zirconium salts, including both inorganic salts, salts with organic anions and complexes. Preferred astringent salts include aluminium, zirconium and aluminium/zirconium halides and halohydrate salts, such as chlorohydrates. When included, levels of incorporation may range from about 0.001% to about 75%, preferably from about 0.5% to about 60%, more preferably from about 5% to about 40% or most preferably from about 10% to about 30% by weight of a composition. Especially preferred aluminium halohydrate salts, known as activated aluminium chlorohydrates, are described in EP 6,739 (Unilever PLC and NV). Zirconium aluminium chlorohydrate actives are also preferred materials, as are the so-called ZAG (zirconium-aluminium-glycine) complexes, for example those disclosed in U.S. Pat. No. 3,792,068 (Procter and Gamble Co.). Zinc phenol sulphonate may also be used and may range up to 3% by weight of the composition.

All of the compositions and methods disclosed and claimed herein can be made and executed without undue experimentation in light of the present disclosure. While the compositions and methods of the present disclosure have been described in terms of preferred embodiments, it will be apparent to those of skill in the art that variations may be applied to the compositions and methods and in the steps or in the sequence of steps of the method described herein without departing from the concept, spirit, and scope of the invention. More specifically, it will be apparent that certain agents, which are chemically related, may be substituted for the agents described herein while the same or similar results would be achieved. All such similar substitutes and modifications apparent to those skilled in the art are deemed to be within the spirit, scope, and concept of the invention as defined by the appended claims.

### EXAMPLES

The present invention is further defined in the following Examples. It should be understood that these Examples, while indicating preferred embodiments of the invention, are given by way of illustration only. From the above discussion and these Examples, one skilled in the art can ascertain the preferred features of this invention, and without departing from the spirit and scope thereof, can make various changes and modifications of the invention to adapt it to various uses and conditions

### Example 1

Determination of Bio-PDO™ Impurities Using GC/MS and GC/FID.

Abstract: Impurities in Bio-PDO™, Lot #MZ41027, were evaluated using gas chromatography-mass spectrometry (GC/MS) with electron impact (EI) ionization, and GC/MS with positive chemical ionization (PCI). These analyses provided information regarding the identity of impurities. In addition, gas chromatography with flame ionization detection (GC/FID) was used to measure the concentration of these impurities based on relative percent area. The determination was performed to better understand the impurities in Bio-PDO™.

Results and Discussion: The impurities in Bio-PDO™, Lot #MZ41027, were first analyzed by GC/MS with electron impact ionization. Four primary impurities were observed. The first impurity eluting at 4.42 min appears to be a dioxane derivative. The highest mass in the mass spectrum is 73 m/z, which could be the molecular ion. However, the fragmentation pattern is similar to that of 1,4-dioxane derivatives, such as 3,6-dimethyl-1,4-dioxane-2,5-dione (MW=144). The second peak observed at 7.29 min is consistent with a silane compound, such as ethenyldimethoxymethyl-silane (MW=132). The largest mass in this mass spectrum is 132 m/z, which could be the molecular ion. The third eluting impurity is observed at 17.36 min and has a fragmentation pattern consistent with an alkyl-1,4-dioxane derivative, such as dimethyl-1,4-dioxane (MW=132). Finally, the peak at 21.88 min is consistent with an unsaturated hydrocarbon with at least one ring structure, and the proposed molecular ion at 176 m/z is consistent with the GC/MS PCI data discussed later.

Additional work with GC/MS with positive chemical ionization (PCI) was performed on this sample, which provides further evidence of the molecular ion, and thus the molecular weight. The GC/MS PCI data confirmed the molecular weights proposed by GC/MS EI data (see Table 3). Unfortunately the first peak, observed at 4.42 min, did not provide sufficient signal to determine the molecular ion. In this case, a stronger signal would be needed to determine if the molecular weight is indeed 73 g/mole.

TABLE 3

| GC/MS Retention Time (min) | Molecular Weight (g/mole) |
|---|---|
| 21.88 | 176 |
| 17.36 | 132 |
| 7.29 | 132 |

The impurities in Bio-PDO™, Lot #MZ41027, were also analyzed using SC/FID to determine the concentration of the impurities. Table 4 is a summary of this analysis based on relative percent area of the peaks. The purity of 1,3-propanediol, based on the GC/FID data, is 99.953%. The flame ionization detector does not detect water, so the purity of 1,3-propanediol may be somewhat less than 99.953%, depending on the concentration of water present.

TABLE 4

| | GC/MS | GC/FID | Impurity |
|---|---|---|---|
| | Retention Time | Retention Time | Concentration |
| Impurity | (min) | (min) | (ppm) |
| 1,4-Dioxane | 4.42 | 2.51 | 7.3 |
| Derivative | | | |
| Silane | 7.29 | 3.73 | 1.3 |
| 1,3-Propanediol | 9.50 | 7.50 | 99.953% |
| Unknown | not observed | 11.96 | 391 |
| Alkyl-1,4-Dioxane | 17.36 | 16.16 | 23.5 |
| Derivative | | | |
| Unknown | 21.88 | 18.22 | 11.3 |

Experimental Section: The Bio-PDO™ Lot #MZ41027, was diluted 1:1 with acetonitrile to reduce the viscosity and facilitate sampling via a syringe with only 10 uL capacity. The 6890 GC used a temperature program with 60C initial temperature, 4 minute hold time, and a ramp rate of 5C per minute up to 260C. The compounds were detected using an Agilent 5973N mass spectrometer detector (MSD) with electron impact ionization. A helium flow rate of 1.5 mL/min was used along with a split ration of 20:1 and an injection volume of 2 uL. The column used was an Agilent HP-5ms column (30 m×0.25 mm×1 um). Some data was obtained using GC/MS with positive chemical ionization (PCI), and the same GC conditions were used. The positive chemical ionization utilized methane to enhance determination of the molecular ion.

The same Bio-PDO™, Lot #MZ41027, prepared as a 1:1 solution with acetonitrile, was also analyzed using GC with flame ionization detection (FID) to determine the concentration of each impurity. The 6890 GC used a temperature program with 60C initial temperature, 4 minute hold time, and a ramp rate of 5C per minute up to 260C. A helium flow rate of 1.5 mL/min was used along with a split ration of 20:1 and an injection volume of 2 uL. The column used was an Agilent HP-5ms column (30 m×0.25 mm×0.25 um). The inlet and detector temperature were both 250C. The FID employed a hydrogen flow rate of 40 mL/min and air flow rate of 450 mL/min, with Helium as the makeup gas.

Conclusions: The concentration, molecular weight, and basic structure of 4 impurities in Bio-PDO™, Lot #MZ41027, has been determined.

### Example 2

Skin Irritation Characterization of Biologically-Derived 1,3-Propanediol

The purpose of this study was to determine the potential of biologically-derived 1,3-propanediol, diluted to concentrations of 5%, 25%, and 50%, to cause irritation or delayed contact hypersensitivity in humans. The method employed in carrying out this test, described below, was similar to that described in “Appraisal of the Safety of Chemicals in Foods, Drugs and Cosmetics” by J. H. Drake and published by the Association of Food and Drug Officials of the United States, the entirety of which is incorporated herein by reference.

Test Panel: The test involved the application of the test article to the upper arms of a group of 112 volunteer panelists. The panelists ranged from 16 to 71 years of age. One hundred and five panelists completed the study. Prior to the initiation of the study, all panelists were in good general health and free of any visible skin disease or anomaly in the area to be patched. Each panelist was required to read, understand and sign an informed consent statement.

Patch Preparation: The test articles (biologically-derived 1,3-propanediol diluted with D.I. water to a concentration of 5%, diluted with D.I. water to a concentration of 25%, and diluted with D.I. water to a concentration of 50%) were applied (0.1 mL) to a one-inch Lintine® Disk (Filter Fabrics, Goshen, Md.) and placed onto a strip of 2 inch Dermicel® hypoallergenic cloth tape (Johnson &Johnson, New Brunswick, N.J.). Before applying this strip, each portion of test material was secured in place with a gloved finger to insure proper application. This tape strip was then pressed into place on the upper left arm of each panelist at its designated test site.

Induction Phase: These patches were applied to their designated contact sites and remained in place for 24 hours. At the end of this period, the patches were removed and the sites were examined for any dermal response. The panelists were then rested for a 24-hour period after which the skin sites were again examined. New patches were then applied to the same sites as previously used. The second applications were identical to the first and remained in place 24 hours. This procedure was repeated on Mondays, Wednesdays and Fridays until a series of nine applications had been made. Patch applications made on Friday were removed by the panelists on Saturday. The panelists examined the sites (with assistance if necessary) for any dermal response at the time of removal and again at 48 hours and reported their observations prior to the next application. The same sites were used throughout the study. In the event when one induction application was missed, the panelist was allowed to make it up at the end of the induction patch period. These patches were applied on Monday following the last scheduled (ninth) induction application on Friday.

Challenge Phase: After the 9th application, a rest period of approximately 2 weeks elapsed after which a challenge application was applied in the same manner and to the same sites described above.

Based upon the effects observed with the test materials placed repeatedly on the skin during both the induction and challenge phases, biologically-derived 1,3-propanediol, diluted to concentrations of 5%, 25%, and 50%, is considered not to be a skin irritant, fatiguing agent, or sensitizing agent under the conditions that prevailed in this study.

### Example 3

A second study to determine the potential of biologically-derived 1,3-propanediol and PG, diluted to concentrations of 25%, 50%, and 75% (pH 4, 7 and 9 tested) to cause irritation or delayed contact hypersensitivity in humans. In this study Bio-PDO™ did not produce any clinically significant dermal irritation or sensitization reactions with concentrations of 25, 50, and 75% Bio-PDO™ at pH 7, or 75% Bio-PDO™ at pH 4 and 9. PG, on the other hand, tested at 25, 50, and 75% (pH 7) produced dermal irritation at all three concentrations.

### Example 4

Bio-PDO™ (≧99.97%), propylene glycol (USP grade, 99.5%) and butylene glycol (anhydrous, 99+%) were used for Cosmetic, Toiletry, and Fragrance Association (CTFA) challenge tests. The neat glycol samples were inoculated with approximately 6×10⁵ fungal spores, incubated and sampled periodically to perform plate counts to determine the number of viable colonies. After four weeks, the glycols were re-challenged using a second inoculation of 6×10⁵ fungal spores. Mold and yeasts used in the testing included Aspergillius niger, Candida albicans, Blue/green Penicillium, and Trichoderma.

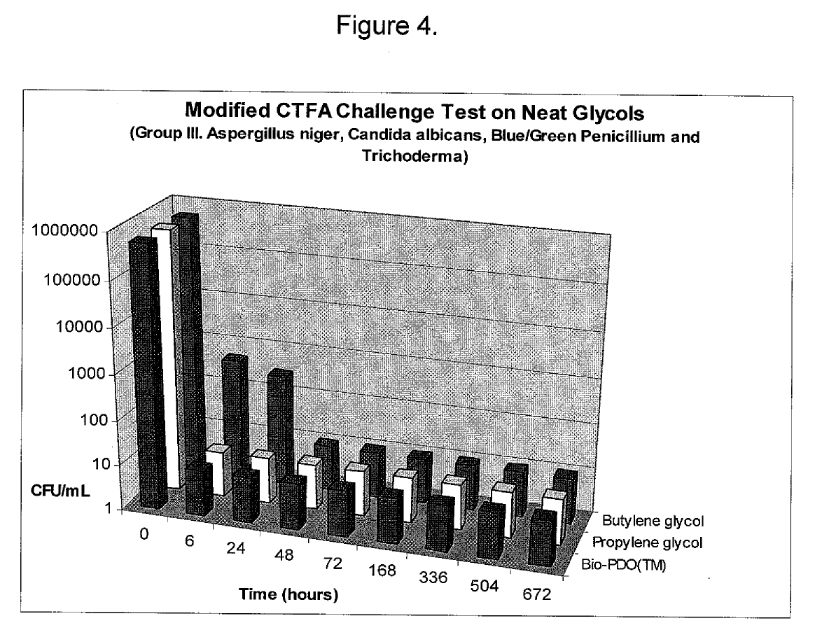

Results: Six hours after inoculation, the number of colonies were <10 in Bio-PDO™ and propylene glycol. (See FIG. 4) In butylene glycol, a slower biocidal effect was observed, and the number of colonies were <10 after 48 hours. After 4 weeks of testing, the second inoculations occurred with very similar results, indicating that butylene glycol has slower biocidal activity against the test fungi as compared to Bio-PDO™ and propylene glycol. Overall, neat Bio-PDO™ showed excellent preservative properties; and is preferred over PG due to the low skin irritation potential.

### Example 5

Oil-in-water formulations containing Bio-PDO™ (≧99.97%), propylene glycol (USP grade, 99.5%) and butylene glycol (anhydrous, 99+%) were also used for similar CTFA challenge tests and for Antimicrobial Preservative Effectiveness Testing (USP <51>). CFTA Tests were performed against two groups: mixture of Staphylococcus aureus, Escherichia coil, Pseudomonas vulgaris and Enterobacter gergoviae (See Table 5), and mixture of Pseudomonas aeruginosa, fluorescens and Flavobacterium sp. (See Table 6). USP<51> Tests were performed against four groups: Staphylococcus aureus (ATCC 6538) (Table 7), Pseudomonas aeruginosa (ATCC 9027) (Table 8), Aspergillus niger (ATCC 16404) (Table 9), Candida albicans (ATCC 10231) (Table 10) and Escherichia coli (ATCC 8739) (Table 11).

Results: The number of colonies in Bio-PDO™ formulations were similar to the number of colonies for both PG and BG. Overall, Bio-PDO™ used in oil-in-water emulsion formulations showed excellent preservative properties; and is preferred over PG due to the low skin irritation potential.

TABLE 5
CTFA Double Challenge Test on Oil-in-water emulsions
Microorganisms - Mixture of Staphylococcus aureus, Escherichia coli, Pseudomonas vulgaris and
Enterobacter gergoviae

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio- | 5.4 × 10⁶ | <10 | <10 | <10 | <10 | <10 | <10 | <10 |
| PDO ™/Paraben | | | | | | | | |
| Repeated | 5.6 × 10⁶ | <10 | <10 | <10 | <10 | <10 | <10 | <10 |
| challenge | | | | | | | | |
| PG/Paraben | 5.7 × 10⁶ | <10 | <10 | <10 | <10 | <10 | <10 | <10 |
| Repeated | 5.5 × 10⁶ | <10 | <10 | <10 | <10 | <10 | <10 | <10 |
| challenge | | | | | | | | |
| Bio- | 5.5 × 10⁶ | <10 | <10 | <10 | <10 | <10 | <10 | <10 |
| PDO ™/(caproyl | | | | | | | | |
| glycol, ethyhexyl | | | | | | | | |
| glycol and | | | | | | | | |
| phenoxy ethanol) | | | | | | | | |
| Repeated | 5.5 × 10⁶ | <10 | <10 | <10 | <10 | <10 | <10 | <10 |
| challenge | | | | | | | | |
| BG/(caproyl | 5.2 × 10⁶ | <10 | <10 | <10 | <10 | <10 | <10 | <10 |
| glycol, ethyhexyl | | | | | | | | |
| glycol and | | | | | | | | |
| phenoxy ethanol) | | | | | | | | |
| Repeated | 5.4 × 10⁶ | <10 | <10 | <10 | <10 | <10 | <10 | <10 |
| challenge | | | | | | | | |
| Bio- | 5.2 × 10⁶ | 2.5 × 10³ | 2.0 × 10³ | 1.75 × 10³ | 0.2 × 10² | <10 | <10 | <10 |
| PDO ™/(caproyl | | | | | | | | |
| glycol, | | | | | | | | |
| dimethicone and | | | | | | | | |
| cetearyl alcohol) | | | | | | | | |
| Repeated | 5.5 × 10⁶ | 1.25 × 10⁴ | 1.025 × 10⁴ | 9.0 × 10³ | 0.75 × 10³ | <10 | <10 | <10 |
| challenge | | | | | | | | |
| BG/(caproyl | 5.8 × 10⁶ | 1.15 × 10⁴ | 5.25 × 10³ | 1.75 × 10³ | 1.75 × 10³ | 0.25 × 10² | <10 | <10 |
| glycol, | | | | | | | | |
| dimethicone and | | | | | | | | |
| cetearyl alcohol) | | | | | | | | |
| Repeated | 5.210⁶ | 1.5 × 10⁴ | 1.45 × 10⁴ | 1.28 × 10⁴ | 4.25 × 10³ | 0.5 × 10² | 0.1 × 10² | <10 |
| challenge | | | | | | | | |

*Counts CFU/mL = Colony Forming Units/mL

TABLE 6
CTFA Double Challenge Test on Oil-in-water emulsions
Mixture of Pseudomonas aeruginosa, fluorescens and Flavobacterium sp.

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio-PDO ™/Paraben | 5.8 × 10⁶ | <10 | <10 | <10 | <10 | <10 | <10 | <10 |
| Repeated challenge | 5.2 × 10⁶ | <10 | <10 | <10 | <10 | <10 | <10 | <10 |
| PG/Paraben | 5.6 × 10⁶ | <10 | <10 | <10 | <10 | <10 | <10 | <10 |
| Repeated challenge | 5.2 × 10⁶ | <10 | <10 | <10 | <10 | <10 | <10 | <10 |
| Bio-PDO ™/(caproyl | 5.7 × 10⁶ | <10 | <10 | <10 | <10 | <10 | <10 | <10 |
| glycol, ethyhexyl | | | | | | | | |
| glycol and phenoxy | | | | | | | | |
| ethanol) | | | | | | | | |
| Repeated challenge | 5.3 × 10⁶ | <10 | <10 | <10 | <10 | <10 | <10 | <10 |
| BG/(caproyl glycol, | 5.3 × 10⁶ | <10 | <10 | <10 | <10 | <10 | <10 | <10 |
| ethyhexyl glycol and | | | | | | | | |
| phenoxy ethanol) | | | | | | | | |
| Repeated challenge | 5.8 × 10⁶ | <10 | <10 | <10 | <10 | <10 | <10 | <10 |
| Bio-PDO ™/(caproyl | 5.4 × 10⁶ | 1.25 × 10⁵ | 9.2 × 10⁴ | 7.5 × 10⁴ | <10 | <10 | <10 | <10 |
| glycol, dimethicone | | | | | | | | |
| and cetearyl alcohol) | | | | | | | | |
| Repeated challenge | 5.4 × 10⁶ | 6.22 × 10⁵ | 3.95 × 10⁵ | 2.43 × 10⁵ | 1.54 × 10⁵ | <10 | <10 | <10 |
| BG/(caproyl glycol, | 5.6 × 10⁶ | 2.22 × 10⁵ | 8.4 × 10⁴ | 1.1 × 10⁴ | <10 | <10 | <10 | <10 |
| dimethicone and | | | | | | | | |
| cetearyl alcohol) | | | | | | | | |
| Repeated challenge | 5.3 × 10⁶ | 6.75 × 10⁵ | 4.11 × 10⁵ | 2.42 × 10⁵ | 1.75 × 10⁵ | <10 | <10 | <10 |

TABLE 7
Antimicrobial Preservative Effectiveness Testing (USP <51>) on Oil-in-
water emulsions
Staphylococcus aureus (ATCC 6538)

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio-PDO ™/Paraben | 1.45 × 10⁶ | <10 | <10 | <10 | <10 | <10 | <10 | <10 |
| PG/Paraben | 1.5 × 10⁶ | <10 | <10 | <10 | <10 | <10 | <10 | <10 |
| Bio-PDO ™/(caproyl | 1.5 × 10⁶ | <10 | <10 | <10 | <10 | <10 | <10 | <10 |
| glycol, ethyhexyl | | | | | | | | |
| glycol and phenoxy | | | | | | | | |
| ethanol) | | | | | | | | |
| BG/(caproyl glycol, | 1.6 × 10⁶ | <10 | <10 | <10 | <10 | <10 | <10 | <10 |
| ethyhexyl glycol | | | | | | | | |
| and phenoxy | | | | | | | | |
| ethanol) | | | | | | | | |
| Bio-PDO ™/(caproyl | 1.5 × 10⁶ | <10 | <10 | <10 | <10 | <10 | <10 | <10 |
| glycol, dimethicone | | | | | | | | |
| and cetearyl | | | | | | | | |
| alcohol) | | | | | | | | |
| BG/(caproyl glycol, | 1.7 × 10⁶ | 2.4 × 10⁴ | 1.8 × 10⁴ | 1.8 × 10² | <10 | <10 | <10 | <10 |
| dimethicone and | | | | | | | | |
| cetearyl alcohol) | | | | | | | | |

*Counts CFU/mL = Colony Forming Units/mL

TABLE 8
Antimicrobial Preservative Effectiveness Testing (USP <51>) on
Oil-in-water emulsions
Pseudomonas aeruginosa (ATCC 9027)

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio-PDO ™/Paraben | 1.45 × 10⁶ | <10 | <10 | <10 | <10 | <10 | <10 | <10 |
| PG/Paraben | 1.45 × 10⁶ | <10 | <10 | <10 | <10 | <10 | <10 | <10 |
| Bio-PDO ™/(caproyl | 1.5 × 10⁶ | <10 | <10 | <10 | <10 | <10 | <10 | <10 |
| glycol, ethyhexyl glycol | | | | | | | | |
| and phenoxy | | | | | | | | |
| ethanol) | | | | | | | | |
| BG/(caproyl glycol, | 1.7 × 10⁶ | <10 | <10 | <10 | <10 | <10 | <10 | <10 |
| ethyhexyl glycol | | | | | | | | |
| and phenoxy ethanol) | | | | | | | | |
| Bio-PDO ™/caproyl | 1.5 × 10⁶ | <10 | <10 | <10 | <10 | <10 | <10 | <10 |
| glycol, dimethicone | | | | | | | | |
| and cetearyl alcohol) | | | | | | | | |
| BG/(caproyl glycol, | 1.45 × 10⁶ | <10 | <10 | <10 | <10 | <10 | <10 | <10 |
| dimethicone and | | | | | | | | |
| cetearyl alcohol) | | | | | | | | |

TABLE 9
Antimicrobial Preservative Effectiveness Testing (USP <51>) on Oil-in-
water emulsions
Aspergillus niger (ATCC 16404)

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio- | 5.7 × 10⁵ | 1.2 × 10³ | <10 | <10 | <10 | <10 | <10 | <10 |
| PDO ™/Paraben | | | | | | | | |
| PG/Paraben | 5.6 × 10⁵ | 2.1 × 10³ | <10 | <10 | <10 | <10 | <10 | <10 |
| Bio- | 5.35 × 10⁵ | 0.6 × 10³ | <10 | <10 | <10 | <10 | <10 | <10 |
| PDO ™/(caproyl | | | | | | | | |
| glycol, ethyhexyl | | | | | | | | |
| glycol and | | | | | | | | |
| phenoxy | | | | | | | | |
| ethanol) | | | | | | | | |
| BG/(caproyl | 5.5 × 10⁵ | 2.3 × 10³ | 0.9 × 10³ | 0.5 × 10³ | <10 | <10 | <10 | <10 |
| glycol, ethyhexyl | | | | | | | | |
| glycol and | | | | | | | | |
| phenoxy | | | | | | | | |
| ethanol) | | | | | | | | |
| Bio- | 5.55 × 10⁵ | 8.3 × 10³ | 3.1 × 10³ | 0.6 × 10³ | 0.3 × 10³ | <10 | <10 | <10 |
| PDO ™/(caproyl | | | | | | | | |
| glycol, | | | | | | | | |
| dimethicone and | | | | | | | | |
| cetearyl alcohol) | | | | | | | | |
| BG/(caproyl | 5.45 × 10⁵ | 7.3 × 10³ | 6.5 × 10³ | 6.1 × 10³ | 4.0 × 10³ | 0.3 × 10³ | <10 | <10 |
| glycol, | | | | | | | | |
| dimethicone and | | | | | | | | |
| cetearyl alcohol) | | | | | | | | |

TABLE 10
Antimicrobial Preservative Effectiveness Testing (USP <51>) on Oil-
in-water emulsions
Candida albicans (ATCC 10231)

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio-PDO ™/Paraben | 5.6 × 10⁵ | <10 | <10 | <10 | <10 | <10 | <10 | <10 |
| PG/Paraben | 5.4 × 10⁵ | <10 | <10 | <10 | <10 | <10 | <10 | <10 |
| Bio-PDO ™/(caproyl | 5.6 × 10⁵ | <10 | <10 | <10 | <10 | <10 | <10 | <10 |
| glycol, ethyhexyl glycol | | | | | | | | |
| and phenoxy ethanol) | | | | | | | | |
| BG/(caproyl glycol, | 5.55 × 10⁵ | <10 | <10 | <10 | <10 | <10 | <10 | <10 |
| ethyhexyl glycol and | | | | | | | | |
| phenoxy ethanol) | | | | | | | | |
| Bio-PDO ™/(caproyl | 5.45 × 10⁵ | 2.1 × 10³ | <10 | <10 | <10 | <10 | <10 | <10 |
| glycol, dimethicone | | | | | | | | |
| and cetearyl alcohol) | | | | | | | | |
| BG/(caproyl glycol, | 5.35 × 10⁵ | 2.6 × 10³ | <10 | <10 | <10 | <10 | <10 | <10 |
| dimethicone and | | | | | | | | |
| cetearyl alcohol) | | | | | | | | |

TABLE 11
Antimicrobial Preservative Effectiveness Testing (USP <51>) on Oil-in-
water emulsions
Escherichia coli (ATCC 8739)

| | Time (days) | | | | | | | |
|---|---|---|---|---|---|---|---|---|
| | 0 | 1 | 2 | 3 | 7 | 14 | 21 | 28 |
| Test Formulation | Counts (CFU/mL) | | | | | | | |
| Bio-PDO ™/Paraben | 1.45 × 10⁶ | <10 | <10 | <10 | <10 | <10 | <10 | <10 |
| PG/Paraben | 1.45 × 10⁶ | <10 | <10 | <10 | <10 | <10 | <10 | <10 |
| Bio-PDO ™/(caproyl | 1.6 × 10⁶ | <10 | <10 | <10 | <10 | <10 | <10 | <10 |
| glycol, ethyhexyl | | | | | | | | |
| glycol and phenoxy | | | | | | | | |
| ethanol) | | | | | | | | |
| BG/(caproyl glycol, | 1.5 × 10⁶ | <10 | <10 | <10 | <10 | <10 | <10 | <10 |
| ethyhexyl glycol and | | | | | | | | |
| phenoxy ethanol) | | | | | | | | |
| Bio-PDO ™/(caproyl | 1.65 × 10⁶ | 0.15 × 10³ | <10 | <10 | <10 | <10 | <10 | <10 |
| glycol, dimethicone | | | | | | | | |
| and cetearyl alcohol) | | | | | | | | |
| BG/(caproyl glycol, | 1.75 × 10⁶ | <10 | <10 | <10 | <10 | <10 | <10 | <10 |
| dimethicone and | | | | | | | | |
| cetearyl alcohol) | | | | | | | | |

What is claimed:

1. A preservative composition comprising biologically-derived 1,3-propanediol and an additive.

2. The composition of claim 1 wherein the 1,3-propanediol has a bio-based carbon content of at least 1%.

3. The composition of claim 1 wherein the 1,3-propanediol has a bio-based carbon content of at least 50%.

4. The composition of claim 1 wherein the 1,3-propanediol has a bio-based carbon content of 100%.

5. The composition of claim 1 wherein the biologically-derived 1,3-propanediol is biologically produced through a fermentation process.

6. The composition of claim 1 wherein the 1,3-propanediol has an ultraviolet absorption at 220 nm of less than about 0.200 and at 250 nm of less than about 0.075 and at 275 nm of less than about 0.075.

7. The composition of claim 1 wherein the 1,3-propanediol has a “b” color value of less than about 0.15 and an absorbance at 275 nm of less than about 0.050.

8. The composition of claim 1 wherein the 1,3-propanediol has a peroxide concentration of less than about 10 ppm.

9. The composition of claim 1 wherein the 1,3-propanediol has a concentration of total organic impurities of less than about 400 ppm.

10. The composition of claim 1 wherein the preservative composition is an antimicrobial, antiviral, antifungal or antiseptic.

11. The composition of claim 1 wherein the additive is selected from the group consisting of carriers, actives, fillers, surfactants, thixotropic agents, antioxidants, preserving agents, dyes, pigments, fragrances, thickeners, vitamins, hormones, moisturizers, UV absorbing sunscreens, UV scattering inorganic sunscreens, wetting agents, cationic, anionic, nonionic, or amphoteric polymers, and hair coloring active substances.

12. The composition of claim 1 wherein the 1,3-propanediol has an anthropogenic CO₂ emission profile of about zero upon biodegradation.

13. A composition comprising a preservative wherein said preservative comprises biologically-derived 1,3-propanediol and an additive.

14. The composition of claim 13 wherein said composition is selected from the group consisting of a cosmetic and personal care composition, a food composition, a tobacco composition, a pharmaceutical composition, a detergent composition, a home care composition, a lubricant composition, a paint and coating composition, an animal food composition, a cryopreservation composition, and an agriculture composition.

15. The composition of claim 13 wherein said preservative is an antimicrobial, antiviral, antifungal or antiseptic.

16. The composition of claim 13 wherein the biologically-derived 1,3-propanediol has a bio-based carbon content of at least 1%.

17. The composition of claim 13 wherein the biologically-derived 1,3-propanediol has a bio-based carbon content of at least 50%.

18. The composition of claim 13 wherein the biologically-derived 1,3-propanediol has a bio-based carbon content of at least 100%.

19. The composition of claim 13 wherein the biologically-derived 1,3-propanediol is biologically produced through a fermentation process.

20. The composition of claim 13 wherein the 1,3-propanediol has an ultraviolet absorption at 220 nm of less than about 0.200 and at 250 nm of less than about 0.075 and at 275 nm of less than about 0.075.

21. The composition of claim 13 wherein the 1,3-propanediol has a “b” color value of less than about 0.15 and an absorbance at 275 nm of less than about 0.050.

22. The composition of claim 13 wherein the 1,3-propanediol has a peroxide concentration of less than about 10 ppm.

23. The composition of claim 13 wherein the 1,3-propanediol has a concentration of carbonyl groups of less than about 400 ppm.

24. The composition of claim 13 wherein the 1,3-propanediol has an anthropogenic CO₂ emission profile of about zero upon biodegradation.

25. The composition of claim 13 wherein the additive is selected from the group consisting of carriers, actives, fillers, surfactants, thixotropic agents, antioxidants, preserving agents, dyes, pigments, fragrances, thickeners, vitamins, hormones, moisturizers, UV absorbing sunscreens, UV scattering inorganic sunscreens, wetting agents, cationic, anionic, nonionic, or amphoteric polymers, and hair coloring active substances.
